(19) United States
(12) Patent Application Publication
(10) Pub. No.: US 2025/0193713 A1
(43) Pub. Date: Jun. 12, 2025

(54) ELECTRONIC DEVICE FOR TRANSMITTING SIGNAL BASED ON BLUETOOTH LOW ENERGY (BLE) AND OPERATION METHOD THEREOF

(71) Applicant: SAMSUNG ELECTRONICS CO., LTD., Suwon-si (KR)

(72) Inventors: Seungbeom SEO, Suwon-si (KR); Sungin SHIN, Suwon-si (KR); Yeonju LIM, Suwon-si (KR)

(21) Appl. No.: 18/928,756

(22) Filed: Oct. 28, 2024

(30) Foreign Application Priority Data
Dec. 11, 2023 (KR) 10-2023-0178478

(51) Int. Cl. H04W 24/08; H04L 5/00; H04W 56/00

(52) U.S. Cl. CPC H04W 24/08; H04L 5/0051; H04W 56/0015

(57) ABSTRACT

The disclosure relates to a 5G or 6G communication system for supporting a higher data transmission rate. According to various embodiments of the disclosure, a method performed by an electronic device may include: identifying a CHS group (CHG) event including a connected hybrid stream (CHS) event; identifying at least one subevent included in the CHS event; transmitting a data packet within a period of a first subevent among the at least one subevent; and receiving a feedback signal based on the data packet within the period of the first subevent.

### CROSS-REFERENCE TO RELATED APPLICATION

This application is based on and claims priority under 35 U.S.C. § 119 to Korean Patent Application No. 10-2023-0178478, filed on Dec. 11, 2023, in the Korean Intellectual Property Office, the disclosure of which is herein incorporated by reference in its entirety.

### BACKGROUND

### 1. Field

The disclosure relates to an electronic device for determining a signal transmission scheme based on Bluetooth low energy (BLE).

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Recently, as technologies using low-cost and low-power wireless devices or wireless links have emerged as a major focus in the field of wireless communication, short-range communication technologies have been increasingly used. A Bluetooth communication scheme, one of the short-range communication technologies, operates in a 2.4 GHz or 5 GHz frequency band and may transmit and receive data within a certain distance (for example, 10 m).

### SUMMARY

Bluetooth communication between electronic devices may be affected by conditions of the electronic devices. For example, in the case of Bluetooth communication without a separate channel access scheme such as listen before talk (LBT), various signal transmission schemes are applied to mitigate interference by another channel. However, in the case of a general Bluetooth signal transmission scheme, a Bluetooth communication connection may be delayed for a high-capacity and high-quality signal, and accordingly, a user of an electronic device may feel inconvenience when using a Bluetooth communication-based service. Therefore, a method for shortening time required for a Bluetooth communication connection in a situation where a delay in a Bluetooth communication connection may occur may be required.

Various embodiments of the disclosure may provide a method for performing a smooth Bluetooth communication connection in a situation where a delay in a Bluetooth communication connection may occur, and an electronic device therefor.

According to various embodiments of the disclosure, an electronic device and a method capable of effectively providing a service in a wireless communication system are provided.

The technical subjects pursued in the disclosure may not be limited to the above-mentioned technical subjects, and other technical subjects which are not mentioned may be clearly understood from the following descriptions by those skilled in the art to which the disclosure pertains.

According to various embodiments of the disclosure, an electronic device may include a communication circuit for Bluetooth low energy (BLE), and a processor coupled with the communication circuit, wherein the processor may be configured to: identify a CHS group (CHG) event including a connected hybrid stream (CHS) event; identify at least one subevent included in the CHS event; transmit a data packet within a period of a first subevent among the at least one subevent; and receive a feedback signal based on the data packet within the period of the first subevent.

According to various embodiments of the disclosure, a method performed by an electronic device may include: identifying a CHS group (CHG) event including a connected hybrid stream (CHS) event; identifying at least one subevent included in the CHS event; transmitting a data packet within a period of a first subevent among the at least one subevent; and receiving a feedback signal based on the data packet within the period of the first subevent.

The disclosure provides an electronic device and a method capable of effectively providing a service in a wireless communication system.

According to an electronic device and a method thereof according to various embodiments, it is possible to determine a transmission scheme and a packet for a Bluetooth communication connection in a situation where a delay in a Bluetooth communication connection may occur, and transmit a signal, thereby smoothly providing a Bluetooth communication-based service to a user even in a situation where a high-capacity or high-quality Bluetooth communication connection is required.

Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device in a network environment according to various embodiments of the present disclosure;

FIG. 2 illustrates a connection between an electronic device and multiple external electronic devices according to various embodiments of the present disclosure;

FIG. 3 illustrates a configuration of an electronic device according to various embodiments of the present disclosure;

FIGS. 4A and 4B illustrate a channel in a frequency band of BLE according to various embodiments of the present disclosure;

FIG. 5 illustrates an example of an ACL transmission technique for transmitting a Bluetooth signal according to various embodiments of the present disclosure;

FIGS. 6A and 6B illustrate examples of a CIS transmission technique for transmitting a Bluetooth signal according to various embodiments of the present disclosure;

FIGS. 7A and 7B illustrate examples of a Bluetooth packet format according to various embodiments of the present disclosure;

FIG. 8 illustrates an example of a HDT packet format for a high-rate transmission according to various embodiments of the present disclosure;

FIG. 9 illustrates a CHS structure and transmission of a signal according to various embodiments of the present disclosure;

FIG. 10 illustrates various examples for determining, based on a CHS structure, at least one subevent according to various embodiments of the present disclosure; and

FIG. 11 illustrates an operation flow of an electronic device for transmitting and receiving, based on a CHS structure a signal according to various embodiments of the present disclosure.

### DETAILED DESCRIPTION

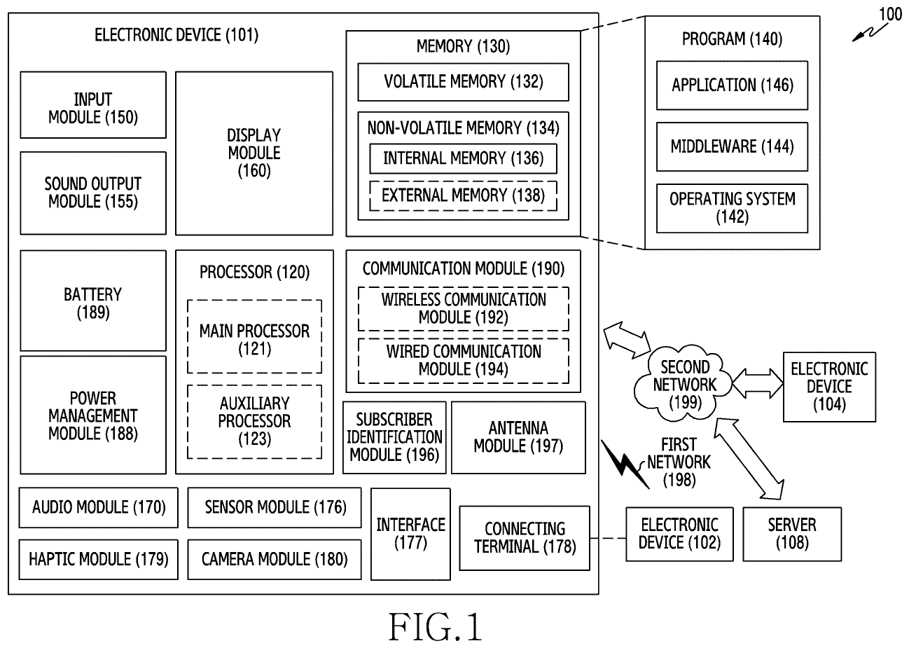

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, exemplary embodiments of the disclosure will be described in detail with reference to the accompanying drawings. It should be noted that, in the accompanying drawings, the same or like elements are designated by the same or like reference signs as much as possible. Also, a detailed description of known functions or configurations that may make the subject matter of the disclosure unnecessarily unclear will be omitted.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more central processing units (CPUs) within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

FIG. 1 illustrates an electronic device in a network environment according to various embodiments of the present disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated into a single component (e.g., the display module 160).

The processor 120 may execute, for example, software (e.g., a program 140) to control at least one other component (e.g., a hardware or software component) of the electronic device 101, coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial model may be generated through machine learning. Such learning may be performed, e.g., by the electronic device 101 where the artificial intelligence model is performed or via a separate server (e.g., the server 108). Learning algorithms may include, but not limited thereto, for example, supervised learning, unsupervised learning, semi-supervised learning, or reinforcement learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep brief network (DBN), a bidirectional recurrent deep neural network (BRDNN), a deep Q-network, and a combination of two or more thereof, but is not limited to the above examples. Additionally or alternatively, the artificial intelligence model may include a software structure, in addition to the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing back multimedia or records. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module).

A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support high-speed transmission of high-capacity data (enhanced mobile broadband (eMBB)), terminal power minimization and multi-terminal access (massive machine type communications (mMTC)), or ultra-reliable and low-latency communications (URLLC). The wireless communication module 192 may support high-frequency bands (e.g., the mmWave band), for example, in order to achieve a high data transfer rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna.

The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to some embodiments, components (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed at a first surface (e.g., the lower surface) of the printed circuit board or adjacent thereto and capable of supporting specified high-frequency bands (e.g., mmWave bands), and a plurality of antennas (e.g., an array antenna) disposed at a second surface (e.g., the upper or side surface) of the printed circuit board or adjacent thereto and capable of transmitting or receiving signals in the specified high-frequency bands.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 may perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101.

The electronic device 101 may provide the outcome, with or without further processing of the outcome, as at least part of a reply to the request. To this end, a cloud computing, distributed computing, mobile edge computing (MEC), or client-server computing technology may be used, for example. The electronic device 101 may provide ultra low-latency services using, for example, distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively,” as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit.” The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Herein, the term “non-transitory”simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

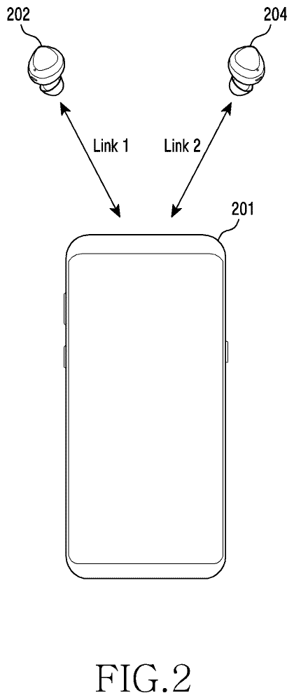

FIG. 2 illustrates a connection between an electronic device and multiple external electronic devices according to various embodiments of the present disclosure.

Referring to FIG. 2, an electronic device 201 may be a master device or a source device which provides data (e.g., audio data or multimedia data). The electronic device 201 may be an electronic device such as a smartphone and may be the electronic device 101 of FIG. 1. According to an embodiment, external electronic device #1 202 and external electronic device #2 204 may be slave devices or sink devices which may receive data from the electronic device 201 and process or output the received data. Each of the external electronic device #1 202 and the external electronic device #2 204 may be the electronic device 102 or the electronic device 104 of FIG. 1.

The electronic device 201 and the external electronic device #1 202 or the electronic device 201 and the external electronic device #2 204 may be connected to each other based on a wireless communication technology (e.g., Bluetooth legacy (or classic) or a Bluetooth low energy (BLE) communication technology) to perform data transmission and reception.

In various embodiments described below, a case where the electronic device 201 transmits data to two external electronic devices 202 and 204 will be described. For example, the electronic device 201 may transmit sound data, which may be provided to a user, to the external electronic device #1 202 and/or the external electronic device #2 204.

According to an embodiment, the external electronic device #1 202 and/or the external electronic device #2 204 may be devices included in one set. For example, the devices included in one set may be devices which are connected through separate communication links to provide a related function in order to provide one integrated service (e.g., stereo sound output or 5.1 channel sound output). For example, the external electronic device #1 202 and the external electronic device #2 204 may be wireless earphone devices operating as one set. In addition, the external electronic device #1 202 may be one of a left external device and a right external device, and the external electronic device #2 204 may be the other one of the left external device and the right external device. In an embodiment, when the external electronic device #1 202 and the external electronic device #2 204 are implemented as wireless earphones, each of the external electronic device #1 202 and/or the external electronic device #2 204 may receive various data (e.g., data for synchronizing sound which may be output from the wireless earphones, data for adjusting sound, or a response signal corresponding to a signal transmitted by the electronic device 201) from the electronic device 201.

In FIG. 2, an example in which the electronic device 201 is connected to two external electronic devices 202 and 204 is described, but the disclosure is not limited thereto, and the electronic device 201 may be connected to three or more different numbers of external electronic devices. In addition, in relation to devices which receive data transmitted by the electronic device 201, various embodiments may be applied not only to external devices but also to other types of devices (e.g., a smartphone, a smartwatch, or a tablet PC) which can communicate wirelessly with the electronic device 201.

According to an embodiment, the electronic device 201 may establish a first communication link (link 1) to perform data communication with the external electronic device #1 202. In an embodiment, the electronic device 201 may establish a second communication link (link 2) to perform data communication with the external electronic device #2 204. In addition, the external electronic device #1 202 and/or the external electronic device #2 204 may be additionally connected through a separate third communication link (not shown) if necessary.

According to an embodiment, connection-oriented communication may be performed through the first communication link and the second communication link. In addition, connectionless communication may be performed between the electronic device 201 and the external electronic device #1 202 and the external electronic device #2 204. The connection-oriented communication and the connectionless communication may be performed through asynchronous or isochronous (ISO) channels.

According to an embodiment, the electronic device 201 may establish a communication link with the external electronic device #1 202 and/or the external electronic device #2 204 or transmit various signals (e.g., an advertising signal) to the external electronic device #1 202 and/or the external electronic device #2 204 for synchronization.

According to an embodiment, the electronic device 201 may receive various information (e.g., connection device information and/or device property information) from the external electronic device #1 202 and/or the external electronic device #2 204, and provide various user interfaces (e.g., a notification or control interface) through a display (e.g., the display module 160 of FIG. 1), based on the received information.

According to an embodiment, the electronic device 201 may transmit and receive a signal for performing various operations described below to and from the external electronic device #1 202 and/or the external electronic device #2 204.

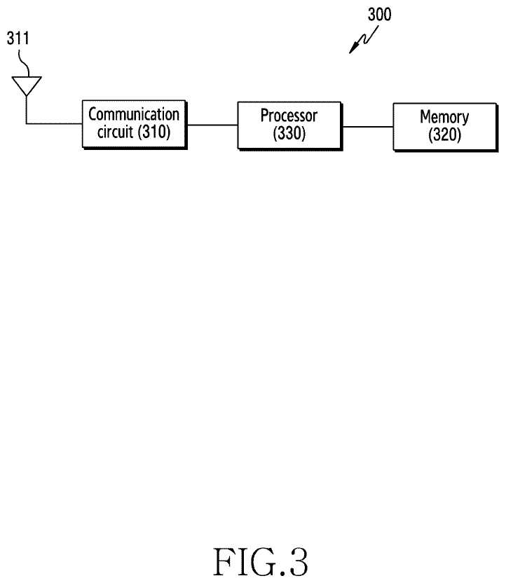

FIG. 3 illustrates a configuration of an electronic device according to various embodiments of the present disclosure.

Referring to FIG. 3, a configuration of an electronic device may be at least one configuration of the electronic device 101 of FIG. 1, the electronic device 201 of FIG. 2, or the external electronic devices 202 and 204 of FIG. 2.

Referring to FIG. 3, an electronic device 300 according to an embodiment of the disclosure may include a communication circuit 310, an antenna module 311, a memory 320, and a processor 330. However, the configuration of the electronic device 300 is not limited thereto, and may include a part of the above-described components of FIG. 3, or may further include at least one other component (e.g., the input module 150 and the display module 160) in addition to the above-described components. In an embodiment, the electronic device 300 may be the electronic device 101 of FIG. 1 and/or the electronic device 201 of FIG. 2. The electronic device 300 of FIG. 3 may include a component same as or similar to at least one of the components (e.g., modules) of the electronic device 101 of FIG. 1. Accordingly, the communication circuit 310 may correspond to the communication module 190 or the wireless communication module 192 of FIG. 1, and the antenna module 311 may correspond to the antenna module 197 of FIG. 1. In addition, the memory 320 and the processor 330 may correspond to the memory 130 and the processor 120 of FIG. 1, and when the electronic device 200 further includes other components, the other components may also correspond to the components of FIG. 1.

The communication circuit 310 may support wireless communication between the electronic device 300 and an external electronic device. For example, the communication circuit 310 may transmit and receive a signal and/or data to and from a first external electronic device or a second external electronic device by using a frequency band supported by wireless communication according to a prescribed wireless communication protocol. In an embodiment, the communication circuit 310 may communicate with the external electronic device through a short-range wireless communication network, such as ultra-wideband (UWB), Bluetooth, Bluetooth low energy (BLE), wireless fidelity (Wi-Fi) direct, or infrared data association (IrDA). In an embodiment, the communication circuit 310 may include a module for Bluetooth legacy communication and/or BLE communication as a wireless communication module. The communication circuit 310 may operate independently of the processor 330 and may include one or more communication processors which support wireless communication. In an embodiment, the communication circuit 310 may also be referred to as a communication interface, a transceiver, or a communication module.

The antenna module 311 may include multiple antennas, and at least one antenna suitable for a communication scheme used in a communication network (e.g., the first network 198 of FIG. 1) may be selected from the multiple antennas by the communication circuit 310.

The memory 320 may store various information for an operation of the electronic device 300. The information stored in the memory 320 may include, for example, input data or output data for software and a command related thereto. In an embodiment, the information stored in the memory 320 may include at least one instruction for auxiliary operations of channel selection and transmission rate selection. The instruction may correspond to the program 140 of FIG. 1. The instruction may be executed by the processor 330, and instructions are executed by the processor 330, so that the electronic device 300 may perform operations according to various embodiments of the disclosure. The memory 320 may include a volatile memory or a non-volatile memory.

The processor 330 (or a controller) may control at least one other component (e.g., a hardware or software component) of the electronic device 300 and perform various data processing or operations. The processor 330 is at least a part of the data processing or operations, and the processor 330 may load a command or data received from another component (e.g., the communication circuit 310) into the memory 320, process the command or data stored in the memory 320, and store the resulting data in the memory 320. According to an embodiment, the processor 330 may execute at least one operation of instructions for channel generation or transmission rate management according to various embodiments of the disclosure described below.

Recently, with the development of electronic devices, the importance of wireless communication between an electronic device (e.g., a smartphone) for providing data and an external electronic device has increased. In particular, in an environment where wireless communication using radio frequency (RF) technology of Bluetooth (BT) or Bluetooth low energy (BLE) is used between electronic devices, an increase in data traffic and high throughput are required, and thus a method for supporting stable lossless streaming is required. The BLE refers to a technology which has a duty cycle of a few milliseconds (ms), unlike the existing Bluetooth communication, and is thus designed to enable the electronic devices to stay in a sleep state for most of the time in order to reduce the power consumption.

According to various embodiments of the disclosure, for convenience of description, an RF communication system such as Bluetooth classic or Bluetooth low energy (BLE) is described below as an example, but the disclosure is not limited thereto. For example, it is obvious that any system having different channel bandwidths (e.g., first communication, second communication, or the like) may be included.

Hereinafter, according to various embodiments of the disclosure, various methods are described for determining an optimal transmission scheme and transmission format and adaptively adjusting a data transmission rate so that an electronic device based on BLE transmits and receives data without a loss or delay in traffic.

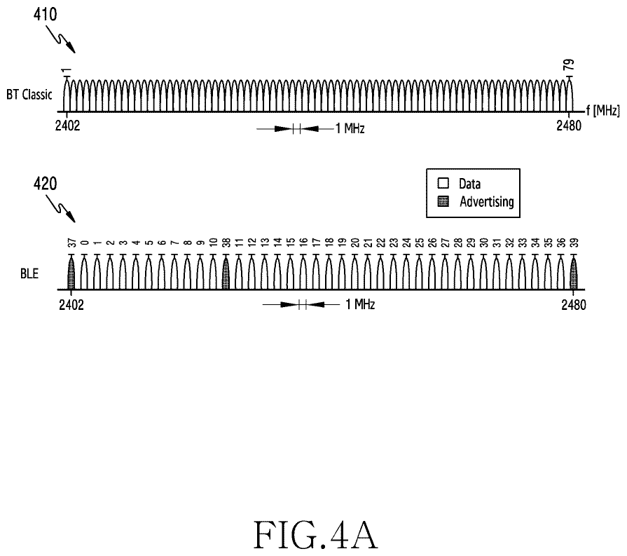

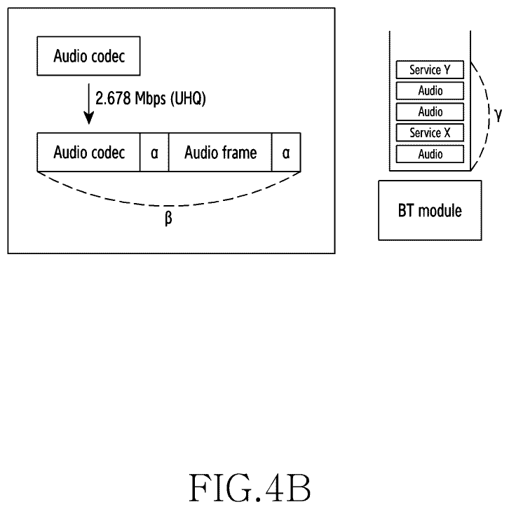

FIG. 4A illustrates a channel in a frequency band according to Bluetooth classic and Bluetooth low energy (BLE) according to various embodiments of the present disclosure. More specifically, FIG. 4A illustrates a frequency band 410 of legacy Bluetooth (e.g., Bluetooth Classic) and a frequency band 420 of BLE within a frequency band range of 2.4 GHz.

According to an example, in the case of the frequency band 410 of Bluetooth classic, each channel may have a bandwidth of about 1 MHz and a maximum data transmission rate of about 3 Mbps, and in this case, the throughput of an application may be about 2.1 Mbps.

According to an example, in the case of the frequency band 420 of BLE, each channel may have a bandwidth of about 1 MHz or 2 MHz, a maximum data transmission rate of about 2 Mbps, and a short operation cycle, so that the throughput of an application may be about 0.7 Mbps. For example, the BLE may employ a Gaussian frequency shift keying (GFSK) modulation scheme and may thus have a transmission rate of 1M (1 Msym/s) or 2M (2 Msym/s), and such a transmission rate may be switched through a long term scheme such as a physical layer update procedure (PHY update procedure). The BLE is highly power-efficient when an average transmission rate is equal to or less than 10 kbps, and thus may be suitable for use in ultra-small Internet of Things (IoT) devices with limited power supply, such as watches, toys, beacons, and wearable computers (wearable devices). However, due to the characteristics of the BLE which periodically transmits a channel and an advertising packet as shown in the BLE frequency band 420 of FIG. 4A, the BLE may not be suitable for high-rate communication or transmission and reception of a large amount of traffic compared to the Bluetooth Classic.

Therefore, according to various embodiments of the disclosure, various methods for high-rate transmission based on high data throughput (BLE HDT) are described so that BLE for low power may achieve higher throughput. Hereinafter, for convenience, various embodiments are described based on a Bluetooth standard (e.g., a Bluetooth special interest group (SIG) standard) or a BLE HDT specification, but are not limited thereto, and any modification or addition of additional elements may be possible as long as a higher transmission rate and throughput may be obtained.

Referring to FIG. 4A, communication based on Bluetooth classic (BT Classic) or BLE may have a narrower channel bandwidth than other unlicensed band communication technologies (e.g., Wi-Fi-based communication), which may cause interference on a channel. In this case, due to the characteristics of Bluetooth communication that does not have a separate channel access mechanism such as listen before talk (LBT), a frequency channel hopping technique may be applied to mitigate channel interference. That is, BLE-based HDT may use frequency diversity between transmissions to mitigate channel interference, and in this case, a cycle or channel selection related to channel hopping may be applied according to the standard specification for BLE HDT. For example, according to the Bluetooth standard specification, a BT-based electronic device may be configured to hop a frequency channel 1600 times per second to mitigate channel interference.

Various embodiments of the disclosure may include a method for determining an adaptive transmission scheme for high-capacity and high-quality HDT and thus improving communication efficiency, including the existing frequency channel hopping technique as described above. More specifically, methods for improving a transmission success ratio and data transmission performance through advancement of a Bluetooth transmission scheme and improvement of the reliability of transmission are described.

According to various embodiments, the following situations may be assumed to improve a transmission rate for lossless data, based on a limited frequency channel and traffic amount.

According to an example, an effective data transmission rate of Bluetooth (hereinafter, for convenience, including both BLE and Bluetooth Classic) may be significantly lower compared to the amount of data that is generally required to be transmitted losslessly. Taking lossless sound source transmission as an example, when a sound source in an ultra high quality (UHQ) format (e.g., 24 bit, 96 kHz), which is a type of high-quality sound source which includes a wide sound range and compensates for distortion, is encoded using a lossless audio codec (e.g., a compression ratio of about 57%), an audio frame of about 2.67 Mbps may be generated. In this case, a transmission rate of an electronic device layer required for streaming without a delay may be as shown in the following equation 1.

$${R}_{P} = {R}_{A} ( 1 + α ) β / γ . \qquad [ Equation 1 ]$$

Here, R_P may refer to a transmission rate of a physical layer, R_A may refer to a transmission rate of an application layer, a may refer to an overhead ratio such as a header or trailer, β may refer to a value obtained by considering retransmission in case of transmission failure, and γ may refer to the ratio of Bluetooth resources used for music streaming. FIG. 4B is an example diagrammatically illustrating such parameters.

Based on equation 1 and FIG. 4B, in case of α=0.1, β=2, and γ=0.5, a physical layer of an electronic device may support a transmission rate of approximately 11.75 Mbps to enable lossless and delay-free music streaming. However, a physical layer transmission rate (e.g., 2, 3, 4, 6, and 7.5 Mbps) of HDT BLE supported by the current Bluetooth standard specification is only up to 7.5 Mbps, and a wider bandwidth or a higher modulation/coding technique is being considered to improve the rate, but there may be a practical limitation due to the possibility of interference with other systems or the cost.

In addition, for lossless and delay-free communication, a method for reducing an overhead a may be considered, but it may be difficult to expect a significant improvement width in the currently optimized overhead reduction technology. Alternatively, a Bluetooth resource allocation ratio γ may be increased, but this may have a limitation in reality. Therefore, the disclosure provides embodiments in which lossless streaming of an electronic device may be performed by determining a transmission scheme for flexibly performing retransmission β. That is, unlike a general Bluetooth transmission scheme, when the electronic device selects an appropriate transmission rate and transmission scheme by considering a channel condition and performs transmission accordingly, this may mean an improvement in a transmission success ratio.

According to various embodiments of the disclosure, a method for improving a channel selection algorithm (CSA) to improve a transmission success ratio is described. According to a CSA defined in the existing Bluetooth standard, a channel may be hopped in the unit of an event (or subevent). However, according to various embodiments, an electronic device may apply a new transmission cycle and unit to hop a channel in the unit of multiple subevents or to variably adjust a transmission length of a subevent period in order to perform retransmission depending on a channel condition.

According to various embodiments of the disclosure, a method for selecting a transmission rate before and after data transmission in order to improve a transmission success ratio is described. An electronic device may optimize resource utilization by determining a transmission rate of a payload including a data packet and the like, depending on a channel condition. For example, when a channel condition is poor but a transmission rate is high, there may be the possibility of transmission failure and retransmission, and when the channel condition is good but the transmission rate is low, inefficiency may occur. Therefore, according to an embodiment, a rate indicator (RI) field may be used to variably apply a payload of a protocol data unit (PDU), and the electronic device may adaptively determine (e.g., modulation, etc.) an appropriate transmission rate of a payload according to an RI, thereby increasing a transmission success ratio and improving transmission performance.

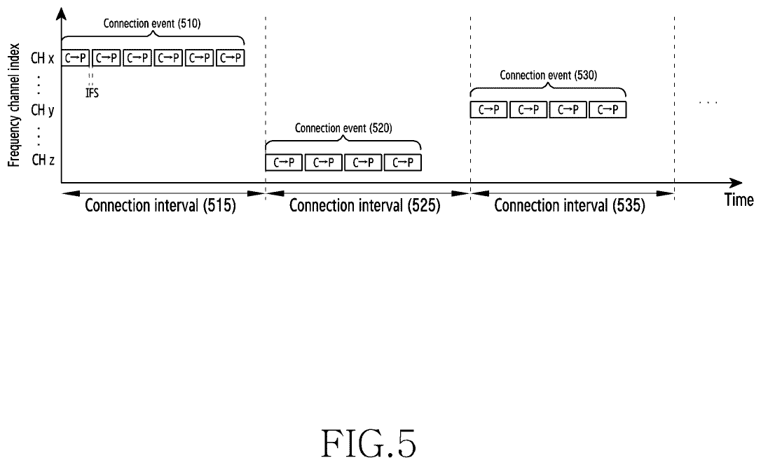

FIG. 5 illustrates an example of an asynchronous connection-oriented logical (ACL) transmission technique for transmitting a Bluetooth signal according to various embodiments of the present disclosure. More specifically, a graph shown with reference to FIG. 5 may be a graph according to an ACL transmission technique which is one of transmission techniques of a general BLE data packet.

Referring to FIG. 5, the horizontal axis of the graph may represent time, and the vertical axis thereof may represent an index (e.g., channel (CH) x, channel y, or channel z) according to a bandwidth of a frequency channel. Referring to FIG. 5, an electronic device may refer to a central device which transmits data, and an external electronic device which receives data from the electronic device may refer to a peripheral device. For example, the external electronic device may include various electronic devices such as a speaker or a headphone.

According to an embodiment, the electronic device of FIG. 5 may hop a channel for transmission every connection interval 515, 525, or 535. For example, the connection interval may generally be 7.5 ms to 4 s. The transmission of data by the electronic device with reference to the connection interval may be to prevent interference with other channels.

According to an embodiment, the electronic device of FIG. 5 may transmit data within a period of a connection event 510, 520, or 530 corresponding to each channel. Within a period of a connection event, the electronic device may transmit data to the external electronic device (e.g., described as C->P for convenience) and receive a feedback signal accordingly (e.g., described as P->C for convenience). According to various embodiments, it is obvious that a feedback signal included in a signal received (P->C) from the external electronic device is only an example and may include various signals including a data signal. According to an embodiment, an inter-frame space (IFS) period for collision avoidance may exist between a period (C->P) for the electronic device to transmit a data signal and a period (P->C) for reception of a feedback signal from the external electronic device. An IFS may generally be 150 us.

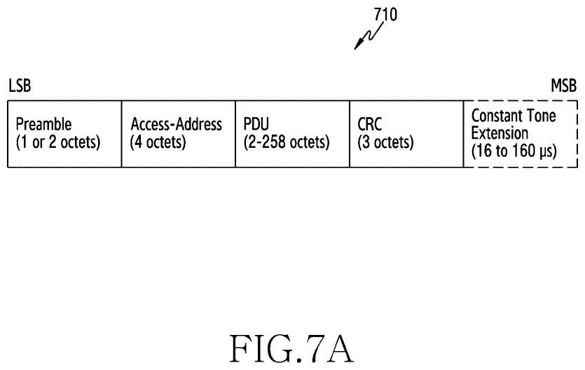

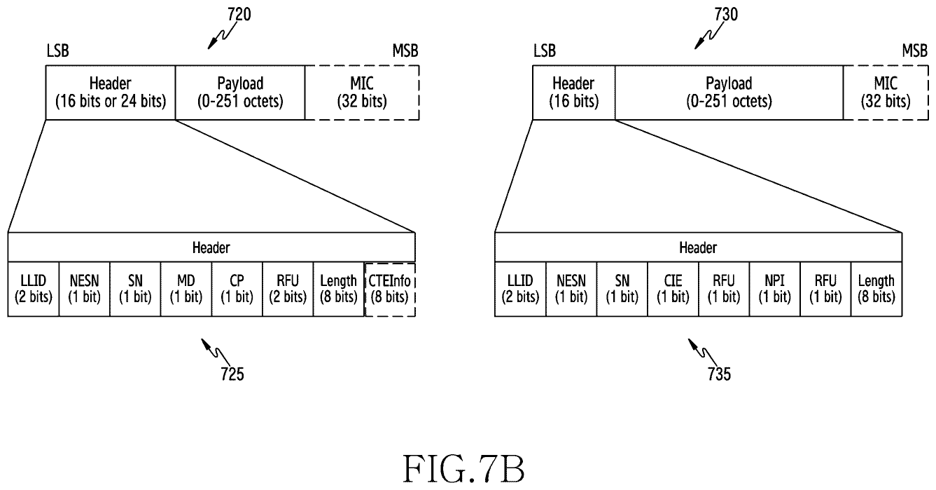

According to an embodiment, referring to FIG. 5, within one connection event 510, 520, or 530, a period (C->P) in which the electronic device transmits data or a period (P->C) in which a feedback signal is received may have a variable length rather than a fixed period, and the number of times may also be variably determined. For example, the variability of a transmission/reception period may be indicated by a more data (MD) field included in a data packet, and this is specifically described in FIG. 7B.

However, when Bluetooth transmission is performed according to the ACL technique illustrated in FIG. 5, it may not be suitable for performing lossless transmission (e.g., lossless audio streaming transmission) based on a packet for HDT communication. In addition, when there are multiple external electronic devices, synchronization (e.g., synchronization of an audio rendering time point) between each external electronic device may be difficult. For example, the ACL-based transmission scheme of FIG. 5 may have a problem in that the concept of an anchor point is absent or sync delay values are not provided for connection for each device.

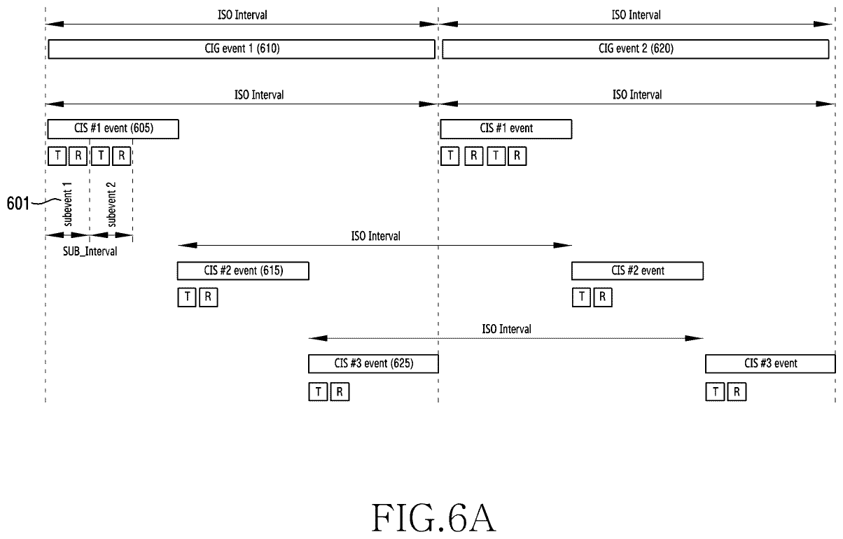

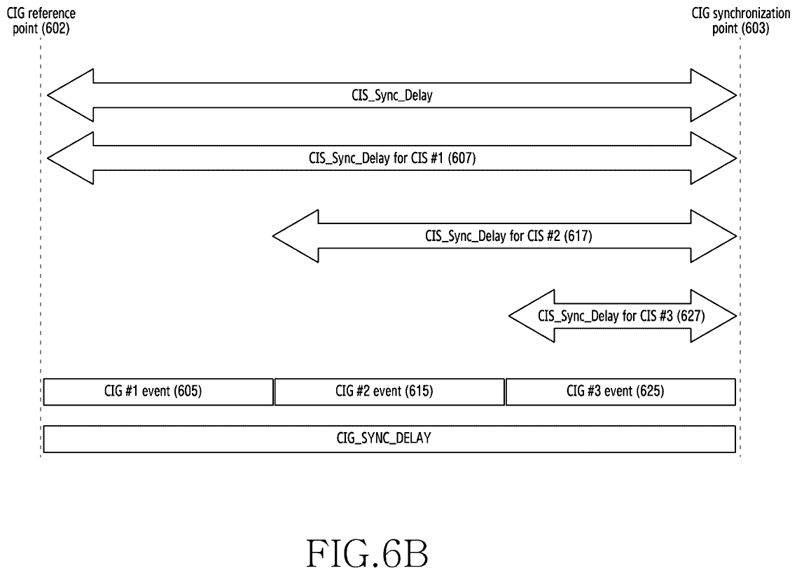

FIGS. 6A and 6B illustrate examples of a connected isochronous stream (CIS) transmission technique for transmitting a Bluetooth signal according to various embodiments of the present disclosure. More specifically, a graph shown with reference to FIG. 6A may be a graph according to a CIS transmission technique which is one of transmission techniques of a general BLE data packet, and a graph shown in FIG. 6B may be a graph for performing synchronization according to the CIS transmission technique.

According to an embodiment, a multi-stream transmission technique is a technique introduced for BLE transmission, which may be for transmitting an independent and synchronized stream between one or more external electronic devices. For example, CIS, which is one of multi-stream transmission techniques, may include a point-to-point data transmission stream between an electronic device and a specific external electronic device, and may include a bidirectional communication protocol through a feedback signal (e.g., acknowledgement (ACK)/negative ACK (NACK)).

Referring to the CIS transmission technique illustrated in FIG. 6A, one or more connected isochronous group (CIG) events 610 and 620 may be configured by the electronic device, and each of the CIG events may include one or more CIS events 605, 615, and 625. For example, each of the CIG events may include up to 31 CIS events. According to an embodiment, each of the CIS events (e.g., a CIS #1 event 605, a CIS #2 event 615, and a CIS #3 event 625) included in the CIG event 610 may refer to a transmission/reception period for each external electronic device exchanging a data packet with the electronic device. According to an embodiment, the CIG events and each of the CIS events may perform periodic streaming transmission with reference to an ISO interval.

According to an embodiment, each of the CIS events 605, 615, and 625 may include one or more subevents 601, and such a subevent 601 may refer to a timing slot or a transmission/reception period for the electronic device and the external electronic device to transmit and receive a data packet by using a specific PDU. Referring to FIG. 6, in a period of the subevent #1 601 within the CIS #1 event 605, the electronic device may transmit data to the external electronic device (illustrated as T for convenience) and receive a feedback signal from the external electronic device (illustrated as R for convenience).

According to an embodiment, referring to FIG. 6A, various parameters as follows may be preconfigured for the electronic device to determine a period for a CIG event and a CIS event:
number of subevents (NSE): this may refer to the number of subevents included in one CIS event. That is, the electronic device may have a fixed number of subevents configured according to the NSE. According to an embodiment, the electronic device in which the NSE is configured may transmit data to the external electronic device within one subevent and receive a feedback signal therefor. In addition, the electronic device may hop a frequency channel in the unit of one subevent to transmit and receive data,
burst number (BN): This may refer to the number of different PDUs which are transmittable in one CIS, and
flush timeout (FT): This may refer to the maximum number of CIS events in which a PDU of each data packet may be transmitted. For example, when, within a specific period, the number of CIS events indicated by an FT value is exceeded, but there are still PDUs remaining that are required to be transmitted (e.g., retransmission due to ACK/NACK is still required even after a time point of the specific period has passed), the electronic device may flush the remaining PDUs.

Referring to FIG. 6B, a synchronization scheme between multiple external electronic devices is illustrated based on the CIS transmission technique. Referring to FIG. 6B, for example, the CIS events 605, 615, and 625 corresponding to the external electronic devices, respectively, may have a starting position for data transmission and reception as an anchor point. In this case, an anchor point of CIS #1, which is the most forward period, may coincide with a CIG reference point.

According to an embodiment, the electronic device may obtain information on an anchor point of each of the CIS events in advance, and identify information on sync delay periods 607, 617, and 627 according thereto in advance. Therefore, the electronic device may apply a synchronization delay value corresponding to each CIS event, and accordingly, multiple external electronic devices may determine the same synchronization point and perform synchronization (e.g., audio rendering, etc.) with reference to the same time point. According to an embodiment, it is obvious that a CIS synchronization delay period including a synchronization delay according to each CIS event may be the same as or different from a CIG synchronization delay period.

According to various embodiments of the disclosure, the CIS transmission technique illustrated through FIGS. 6A and 6B may be effective in a case where exchange of a data packet required to be transmitted at a constant cycle or communication with multiple external electronic devices is required. However, as with the ACL transmission technique of FIG. 5, the CIS transmission technique may not be suitable for transmitting a high-capacity and high-quality HDT packet. For example, according to the CIS transmission technique, channel hopping may occur for each subevent, and accordingly, a transmission result (e.g., a feedback) in the previous subevent may be difficult to be reflected in the next subevent. That is, it may be difficult to adaptively use a channel state or a transmission result of the previous subevent to determine a transmission rate of the next subevent. In addition, since a packet for HDT communication may have a different transmission rate for a PDU (e.g., the length of a payload) and may require retransmission for each divided payload (e.g., chunk), it is efficient to have a variable length of a subevent, but a subevent of the CIS transmission technique is already fixed during a configuration process and may thus be difficult to be changed thereafter.

Therefore, various embodiments of the disclosure describe a structure and a transmission scheme for solving a problem of the above-described technique. Hereinafter, to this end, the specific content of a packet structure of data to be transmitted is described.

FIGS. 7A and 7B illustrate examples of a Bluetooth packet format according to various embodiments of the present disclosure. Specifically, FIG. 7A illustrates an example of a format of an LE uncoded link layer packet, and FIG. 7B illustrates an example of a protocol data unit (PDU) format included in a Bluetooth packet format.

Referring to FIG. 7A, a packet format 710 of legacy BLE may include a preamble field, an access-address field, a PDU packet, a cyclic redundancy check (CRC) field, or a constant tone extension (CTE) field.

According to an embodiment, the PDU packet may have a size of up to 258 bytes.

According to an embodiment, the CTE field may not be verified by a CRC and may not be included in an isochronous channel (e.g., an isochronous physical channel) packet.

Referring to FIG. 7B, a data physical channel PDU 720 and a header format relating thereto and an isochronous physical channel PDU 730 and a header format relating thereto are illustrated.

According to various embodiments of the disclosure, a data channel PDU 720 may include a header 725, a payload, and a message integrity check (MIC) field.

According to an embodiment, the header 725 of the data channel PDU may include a logical link identification (LLID) field indicating whether a data PDU or a control PDU is indicated, a next expected sequence number (NESN) field used to include an ACK/NACK of an external electronic device, a sequence number (SN) field used to indicate whether a packet is a retransmission packet, a more data (MD) field indicating whether there is additional transmission data, a CTEInfo present (CP) field indicating whether a CTE field is included, a reserved for future use (RFU) field, a length field for a unit length, and a CTEInfo field including CTE information.

According to an embodiment, the payload of the data channel PDU may include a payload for transmitting data or a payload for controlling a link layer and may have a length of up to 251 octets.

According to an embodiment, whether the data channel PDU includes the MIC field may be determined depending on whether encryption is performed, and if the MIC field is included, the MIC field may have a length of 32 bits.

According to various embodiments of the disclosure, an isochronous channel PDU 730 may include a header 735, a payload, and a message integrity check (MIC) field.

According to an embodiment, the header 735 of the isochronous channel PDU may include a logical link identification (LLID) field indicating a payload type of a CIS data PDU, a next expected sequence number (NESN) field used to include an ACK/NACK of an external electronic device, a sequence number (SN) field used to indicate whether a packet is a retransmission packet, a closed isochronous event (CIE) field used to indicate early termination of a CIS event when transmission of a payload is completed in the last subevent, a null PDU indicator (NPI) field indicating whether a packet is a CIS data PDU or a CIS Null PDU, a reserved for future use (RFU) field, and a length field for a unit length. For example, the header 735 of the isochronous channel PDU may include a CIE field and an NPI field instead of an MD field and a CTE-related field, compared to the header 725 of the data channel PDU.

According to an embodiment, the payload of the isochronous channel PDU may have a length of up to 251 octets.

According to an embodiment, whether the isochronous channel PDU includes the MIC field may be determined depending on whether encryption is performed, and if the MIC field is included, the MIC field may have a length of 32 bits.

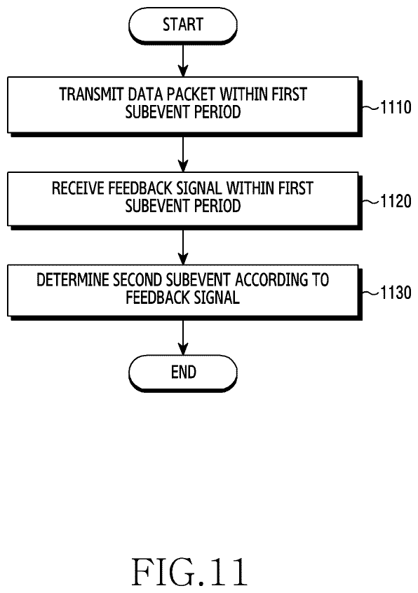

However, the above-described format is only an example of a packet format for the existing BLE transmission technique, and various embodiments of the disclosure below may include a packet format including at least one of some or a combination of some of the above-described fields, depending on operations and configurations of the embodiments. For example, according to an embodiment, for a transmission technique for HDT communication according to FIGS. 11 to 13, an electronic device may include a combination of some fields (e.g., including an MD field) of the header 725 or some fields (e.g., a CIE field or an NPI field) of the header 735. In addition, according to embodiments of the disclosure, a header, etc. of a packet or a PDU packet may further include an RI field for adjusting a transmission rate (e.g., the length of a payload) for HDT communication, a field for an FT value, or the like. That is, it is obvious that a packet format according to various embodiments of the disclosure may include a combination or modification of some of FIGS. 7A and 7B described above, as required by a transmission technique specifically described in FIGS. 11 to 13.

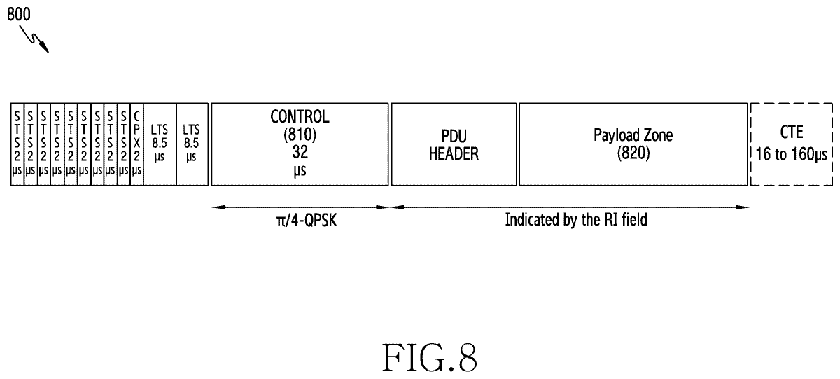

FIG. 8 illustrates an example of a high data throughput (HDT) packet format for high-rate transmission according to various embodiments of the disclosure. More specifically, referring to FIG. 8, a packet format of HDT communication for selecting a transmission rate before and after data transmission in order to improve a transmission success ratio is specifically described.

According to an embodiment, referring to FIG. 8, a packet structure 800 according to a Bluetooth standard specification for BLE HDT communication is illustrated. According to the packet structure 800, before transmitting a payload including a data packet, an electronic device may preemptively transmit a short training sequence (STS) or a long training sequence (LTS) for modulation of a data payload. Generally, the STS may include four symbols corresponding to QPSK constellation points (e.g., {−1,−j, +j, +1}) for quadrature phase shift keying (QPSK) modulation, and the LTS may include 17 symbols as a Zadoff-Chu sequence for more specific parameter measurement. According to an embodiment, the packet structure 800 corresponding to a BLE HDT packet structure may include a training sequence of 37 us and a control field 810 of 32 us, which may be for QPSK modulation. In addition thereto, the packet structure 800 may further include a packet (hereinafter, for convenience, used interchangeably with a data packet) including a PDU header and a PDU payload 820, and a CTE field.

According to an embodiment, in BLE HDT communication for high-rate communication, a transmission rate may be variably adjusted through an RI field included in the control field 810, rather than being switched according to an update procedure of a physical layer. For example, the RI field included in the control field 810 may indicate a rate of a payload and adjust a length, as shown in Table 1 below.

TABLE 1

| HDT | | | | | |
|---|---|---|---|---|---|
| Designation | HDT2 | HDT3 | HDT4 | HDT6 | HDT7.5 |
| Modulation Scheme | $\text{} \begin{matrix}\frac{π}{4} - \\ QPSK\end{matrix}$ | $\text{} \begin{matrix}\frac{π}{4} - \\ QPSK\end{matrix}$ | 8PSK | 16QAM | 16QAM |
| FEC rate | 1/2 | 3/4 | 2/3 | 3/4 | 15/16 |
| Bit Rate | 2 Mb/s | 3 Mb/s | 4 Mb/s | 6 Mb/s | 7.5 Mb/s |

For example, when the RI field indicates a transmission rate corresponding to HDT4, the payload 820 may be modulated by 8 phase shift keying (PSK) and may have a forward error correction (FEC) rate of 2/3 and a bit rate of 3 Mb/s. For another example, when the RI field indicates a transmission rate corresponding to HDT7.5, the payload 820 may be modulated by 16 quadrature amplitude modulation (QAM) and may have an FEC rate of 15/16 and a bit rate of 7.5 Mb/s. According to various embodiments, as described above, a physical layer for HDT communication may perform rate adaptation in the unit of a packet to improve throughput.

According to an embodiment, the size of the payload 820 of FIG. 8 may be up to 8191 bytes. In order to facilitate control of an HDT payload having such a large size, the payload 820 may be divided into up to 16 divided payloads (e.g., chunks). Each of the divided payloads may include an individual CRC and may have a size of up to 511 bytes. According to an embodiment, an external electronic device which transmits a feedback signal may transmit a selective feedback signal for each of the divided payloads. The selective feedback signal may be transmitted in the form of a bitmap including a bit corresponding to each of the divided payloads. For example, in relation to transmission of a payload divided into 8 payloads, when all transmissions are successful, the external electronic device may transmit an ACK signal (e.g., bit stream {11111111}) to the electronic device. Alternatively, when some transmissions fail, the external electronic device may transmit a NACK signal (e.g., bit stream {11010111}) to the electronic device, and accordingly, the electronic device may identify a payload portion which has failed to be transmitted and retransmit only the divided payload corresponding to the portion.

However, the above-described format is only an example of a packet format for the existing HDT communication, and various embodiments of the disclosure below may include a packet format including at least one of some or a combination of some of the above-described fields, depending on operations and configurations of the embodiments. For example, according to an embodiment, for a transmission technique for HDT communication according to FIGS. 11 to 13, the electronic device may include some fields (e.g., an RI field of the control field 810) of the HDT packet format 800 or a combination of those fields. In addition thereto, according to embodiments of the disclosure, a header, etc. of a packet or a PDU packet may further include some or a combination of some of the fields described in FIGS. 7A and 7B. That is, it is obvious that a packet format according to various embodiments of the disclosure may include a combination or modification of some of FIG. 8 described above, depending on HDT communication required by a transmission technique specifically described in FIGS. 11 to 13.

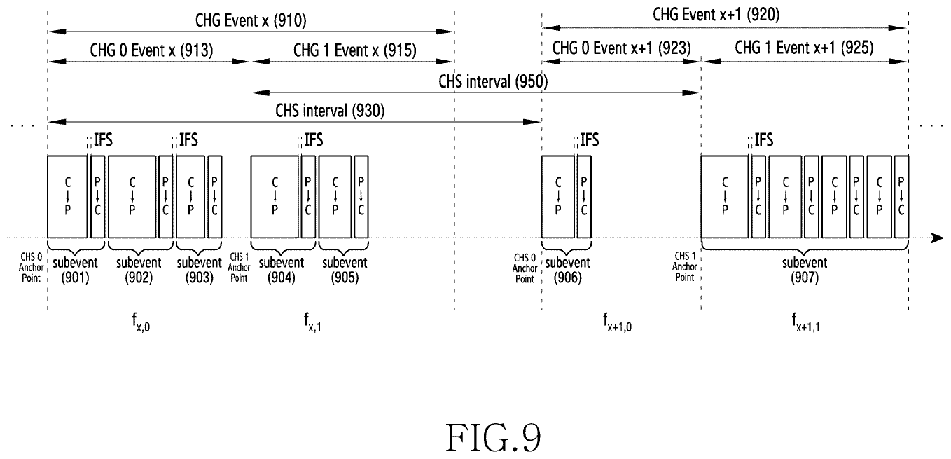

FIG. 9 illustrates a connected hybrid stream (CHS) structure and transmission of a signal according to various embodiments of the present disclosure. More specifically, referring to FIG. 9, an example of a transmission scheme for losslessly streaming high-capacity and high-quality data according to various embodiments of the disclosure is illustrated.

According to various embodiments, unlike a general BLE transmission technique, a connected hybrid stream (CHS) transmission technique and a structure according thereto may be newly defined. However, the terms and names described below are only examples, and it is obvious that, according to an embodiment, transmission techniques with various names which include a structure similar to or identical to a CHS structure may be included.

According to an embodiment, the CHS structure may include a CHG (CHS group or connected hybrid group) event 910 and 920. Referring to FIG. 9, CHG event x 910 and CHG event x+1 920 are illustrated, but this is only an example, and it is obvious that more consecutive CHG events may be included. According to an embodiment, an electronic device may perform frequency hopping in the unit of each CHG event. For example, the electronic device may transmit and receive a signal through channel x during a CHG event x period, and then, hop a frequency channel to transmit and receive a signal through channel y (here, y is only an example and may refer to another channel) during a CHG event x+1 period.

According to an embodiment, a CHG may include CHS events 913, 915, 923, and 925. Referring to FIG. 9, the CHG event x 910 may include CHS 0 event x 913 and CHS 1 event x 915, and the CHG event x+1 920 may include CHS 0 event x+1 923 and CHS 1 event x+1 925. According to an embodiment, each CHS included in a CHG event may correspond to each external electronic device from and to which the electronic device transmits and receives a signal. For example, for the electronic device which performs communication with an external electronic devices, a CHG event may include n CHS events, and the electronic device may exchange a packet with a corresponding external electronic device within a period of each CHS event (e.g., a CHS 0 event, a CHS 1 event, . . . , and a CHS n−1 event).

Considering the above, referring to FIG. 9, the electronic device may exchange a packet with external electronic device #0 within a period of the CHS 0 event x 913 included in the CHG event x 910, and after a CHS interval 930, hop to another channel to exchange a packet with the external electronic device #0 within a period of the CHS 0 event x+1 923 included in the CHG event x+1 920. Similarly, the electronic device may exchange a packet with external electronic device #1 within a period of the CHS 1 event x 915 included in the CHG event x 910, and after a CHS interval 950, hop to another channel to exchange a packet with the external electronic device #1 within a period of the CHS 1 event x+1 925 included in the CHG event x+1 920. According to various embodiments, it is obvious that a greater number of CHS events may be included depending on the number of connected external electronic devices, and a greater number of CHG events may be included based on transmission cycle information or a channel.

According to an embodiment, the CHS events 913, 915, 923, and 925 may include at least one subevent 901 to 907. According to an embodiment, the electronic device may perform two times of signal transmission and reception within each of the at least one subevent. For example, within the subevent 901, the electronic device may transmit a data packet to an external device (e.g., external electronic device #0) (for convenience, expressed as C->P) and receive a feedback signal corresponding thereto from the external device (for convenience, expressed as P->C). However, this is only an example, and it is obvious that a signal received from the external device may include various signals such as a data signal and a control signal, including a feedback signal.

According to an embodiment, the number of at least one subevent included in the CHS events 913, 915, 923, and 925 may be variable. A packet or a feedback signal transmitted and received within a subevent having the CHS structure of FIG. 9 may include an MD field. In this case, the number of subevents transmitted within the CHS event may be determined based on information indicated by the MD field. For example, within one CHS event, even when the electronic device transmits a packet through one subevent and receives an ACK signal corresponding thereto to identify that the transmission is completed, if the MD field indicates that more data needs to be transmitted, the electronic device may further allocate another subevent and may be configured to transmit data required to be transmitted through an additional subevent.

According to an embodiment, the length of at least one subevent included in the CHS events 913, 915, 923, and 925 may be variable. For example, a packet and a feedback signal transmitted and received within a subevent having the CHS structure of FIG. 9 may include a packet for HDT communication of FIG. 8. Therefore, the length of a payload may be adjusted according to a rate indicated by an RI field included in a packet transmitted within a subevent, and accordingly, the length of each subevent may also vary.

In addition, after a default subevent (e.g., the subevent 901), the length of a packet required to be transmitted for the next subevent (e.g., the subevent 902) may vary depending on a channel state of the previous subevent, and thus the length of the subevent may also vary. For example, as described in FIG. 8, a payload of a packet transmitted by the electronic device may be divided into multiple divided payloads (e.g., chunks), and the electronic device may divide the payloads and receive a feedback signal corresponding to each divided payload from an external electronic device. The electronic device having received a feedback signal may determine the changed subevent length by transmitting only the divided payloads required to be retransmitted to the external electronic device based on the feedback signal.

Ultimately, the length of each subevent included in a CHS may not be a fixed value, but may be variable, as it may be adjusted by an RI field or by a feedback signal, based on a format for HDT communication.

According to an embodiment, each payload transmitted by the electronic device may include an FT value. Therefore, the electronic device may flush a payload that is not transmitted until the number of maximum CHS events (e.g., CHS event x, CHS event x+1, . . . , and CHS event n) depending on the FT value is reached. According to an embodiment, each payload transmitted by the electronic device may include a CIE value. Therefore, when transmission of a payload in the last subevent is completed, the electronic device may terminate a CHS event early, based on a CIE field.

According to an embodiment, CHS events included in each CHG event may have a corresponding CHS anchor point time point. For example, in a period of the CHG event x 910, a CHS 0 anchor point (in this case, the CHS 0 anchor point may be the same as a CHG reference point), which is a starting point of the CHS 0 event x 913, may be defined, and a CHS 1 anchor point, which is a starting point of the CHS 1 event x 915, may be defined. According to an embodiment, the electronic device may obtain information on an anchor point of a CHS event corresponding to each external electronic device in advance and identify information on a sync delay period according thereto in advance. Therefore, the electronic device may apply a synchronization delay value corresponding to each CHS event, and accordingly, multiple external electronic devices may determine the same synchronization point and perform synchronization (e.g., audio rendering, etc.) with reference to the same time point.

As described above, in the CHS structure according to various embodiments of the disclosure, the number of subevents or the length of a subevent is not a fixed value, and thus it is effective for rate adaptation and is possible to maximize the use of time resources within each event. In addition, based on communication with one external electronic device, the electronic device may hop a channel in the unit of a CHS event, and may thus use a transmission result of the previous subevent to determine a transmission rate of the next subevent. In addition, since the length of a subevent varies, the electronic device may be suitable for a variable transmission rate of a packet for an HDT and retransmission characteristics for each divide payload and may apply the same synchronization time point for each connection by using an anchor point and a synchronization delay value.

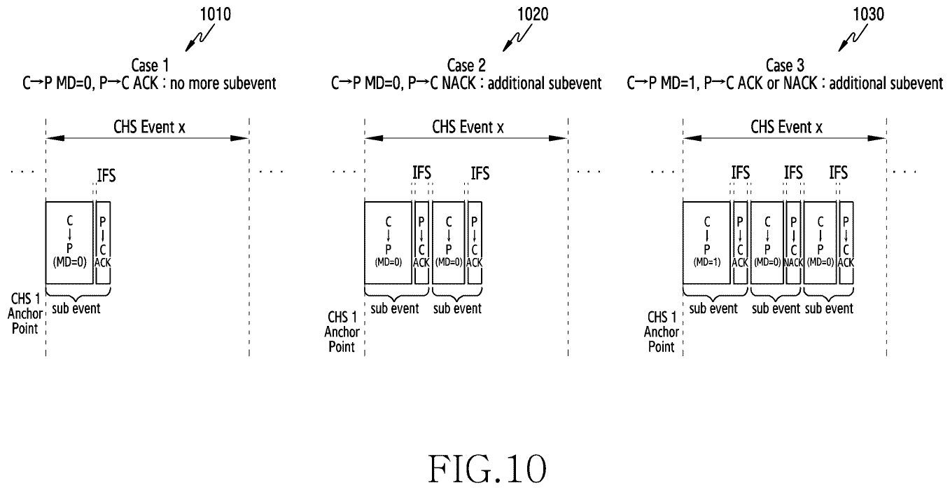

FIG. 10 illustrates various examples for determining at least one subevent based on a CHS structure according to various embodiments of the present disclosure. More specifically, FIG. 10 illustrates various examples of transmission and reception between an electronic device and an external electronic device according to the CHS structure of FIG. 9. According to an embodiment, each situation of FIG. 10 may include an example of being allocated within a CHS event period of one of the CHS events 913, 915, 923, and 925 of FIG. 9.

Referring to FIG. 10, a first situation 1010 illustrates a case where a packet transmitted by an electronic device to an external electronic device includes an MD field indicating 0, and an ACK is received from the external electronic device as a feedback signal for the packet. Here, an ACK/NACK may include a selective ACK/NACK. For example, when transmission of some of data packets transmitted by the electronic device is identified as a failure, the external electronic device may transmit a NACK as a feedback signal to the electronic device along with an indicator for the packets having failed to be transmitted.

According to an embodiment, in the first situation 1010, the electronic device may transmit (C->P) a data packet to the external electronic device within one subevent period included in a CHS event. The data packet transmitted by the electronic device may include an MD field indicating 0. The electronic device may receive a feedback signal from the external electronic device after an IFS from a time point at which the data packet is transmitted. In this case, an IFS period is only an example and may be omitted. According to an embodiment, the feedback signal may include an ACK. The ACK included in the feedback signal may be used to indicate that transmission of all of multiple divided payloads of the data packet transmitted by the electronic device has been completed. In the case of the first situation 1010, the electronic device may determine that there is no more additional data to be transmitted, based on the MD field, and also, may receive an ACK to determine that there is no data required to be retransmitted. Therefore, in this case, the electronic device may not allocate an additional subevent within the CHS event and may prevent unnecessary waste of time resources or overhead.

Referring to FIG. 10, a second situation 1020 illustrates a case where a packet transmitted by an electronic device to an external electronic device includes an MD field indicating 0, and a NACK is received from the external electronic device as a feedback signal for the packet. Here, an ACK/NACK may include a selective ACK/NACK. For example, when transmission of some of data packets transmitted by the electronic device is identified as a failure, the external electronic device may transmit a NACK as a feedback signal to the electronic device along with an indicator for the packets having failed to be transmitted.

According to an embodiment, in the second situation 1020, the electronic device may transmit (C->P) a data packet to the external electronic device within one subevent period included in a CHS event. The data packet transmitted by the electronic device may include an MD field indicating 0. The electronic device may receive a feedback signal from the external electronic device after an IFS from a time point at which the data packet is transmitted. In this case, an IFS period is only an example and may be omitted. According to an embodiment, the feedback signal may include a NACK. The NACK included in the feedback signal may be used to indicate that transmission of some of multiple divided payloads of the data packet transmitted by the electronic device has failed. In the case of the second situation 1020, the electronic device may determine that there is no more additional data to be transmitted, based on the MD field, but may receive a NACK to determine that there is remaining data required to be retransmitted. Therefore, in this case, the electronic device may allocate an additional subevent within the CHS event.

According to an embodiment, in the case of the second situation 1020, an additional subevent may be allocated to the electronic device that requires retransmission. According to an embodiment, the electronic device may retransmit (C->P), to the external electronic device, some divided payloads having failed to be transmitted, within another subevent period included in the CHS event. According to an embodiment, a data format retransmitted by the electronic device may include an HDT packet format, and thus may be rate-adjusted (e.g., by applying a different modulation scheme) according to a payload having a different transmission rate. As described above, since a number of packets or a transmission rate for transmission of data packets by the electronic device varies, a first subevent and a second subevent may have different lengths.

According to an embodiment, a data packet retransmitted by the electronic device may include an MD field indicating 0. The electronic device may receive a feedback signal including an ACK from the external electronic device after an IFS from a time point at which the data packet is retransmitted. The ACK included in the feedback signal may be used to indicate that transmission of all of multiple divided payloads of the data packet retransmitted by the electronic device has been completed. In the case of the second situation 1020, the electronic device may determine that there is no more additional data to be transmitted, based on the MD field, and also, may receive an ACK to determine that there is no data required to be retransmitted. Therefore, in this case, the electronic device may not allocate an additional subevent within the CHS event and may prevent unnecessary waste of time resources or overhead.

Referring to FIG. 10, a third situation 1030 illustrates a case where a packet transmitted by an electronic device to an external electronic device includes an MD field indicating 1, and an ACK or NACK is received from the external electronic device as a feedback signal for the packet. Here, an ACK/NACK may include a selective ACK/NACK. For example, when transmission of some of data packets transmitted by the electronic device is identified as a failure, the external electronic device may transmit a NACK as a feedback signal to the electronic device along with an indicator for the packets having failed to be transmitted.

According to an embodiment, in the third situation 1030, the electronic device may transmit (C->P) a data packet to the external electronic device within one subevent period included in a CHS event. The data packet transmitted by the electronic device may include an MD field indicating 1. The electronic device may receive a feedback signal from the external electronic device after an IFS from a time point at which the data packet is transmitted. In this case, an IFS period is only an example and may be omitted. According to an embodiment, the feedback signal may include an ACK. The ACK included in the feedback signal may be used to indicate that transmission of all of multiple divided payloads of the data packet transmitted by the electronic device has been completed. In the case of the third situation 1030, the electronic device may receive an ACK to determine that there is no data required to be retransmitted, but may determine that there is additional data remaining to be transmitted, based on the MD field. Therefore, in this case, the electronic device may allocate an additional subevent within the CHS event.

According to an embodiment, in the case of the third situation 1030, an additional subevent may be allocated to the electronic device that requires transmission of additional data. According to an embodiment, the electronic device may transmit (C->P), to the external electronic device, additional data required to be transmitted, within another subevent period included in the CHS event. According to an embodiment, additional data format transmitted by the electronic device may include an HDT packet format, and thus may be rate-adjusted (e.g., by applying a different modulation scheme) according to a payload having a different transmission rate. As described above, since a number of packets or a transmission rate for transmission of data packets by the electronic device varies, a first subevent and a second subevent may have different lengths. According to an embodiment, a data packet additionally transmitted by the electronic device may include an MD field indicating 0.

The electronic device may receive a feedback signal including a NACK from the external electronic device after an IFS from a time point at which the additional data packet is transmitted. The NACK included in the feedback signal may be used to indicate that transmission of some of multiple divided payloads of the data packet additionally transmitted by the electronic device has failed. In the case of the third situation 1030, the electronic device may determine that there is no more additional data to be transmitted, based on the MD field, but may receive a NACK to determine that there is remaining data required to be retransmitted. Therefore, in this case, the electronic device may allocate an additional another subevent within the CHS event.

According to an embodiment, in the case of the third situation 1030, an additional another subevent may be allocated to the electronic device for additional data required to be retransmitted. According to an embodiment, the electronic device may retransmit (C->P), to the external electronic device, some divided payloads having failed to be transmitted, within another subevent period included in the CHS event. According to an embodiment, a data format retransmitted by the electronic device may include an HDT packet format, and thus may be rate-adjusted (e.g., by applying a different modulation scheme) according to a payload having a different transmission rate. As described above, since a number of packets or a transmission rate for transmission of data packets by the electronic device varies, a first subevent, a second subevent, or a third subevent may have a different length. According to an embodiment, a data packet retransmitted by the electronic device may include an MD field indicating 0.

The electronic device may receive a feedback signal including an ACK from the external electronic device after an IFS from a time point at which the data packet is retransmitted. The ACK included in the feedback signal may be used to indicate that transmission of all of multiple divided payloads of the data packet retransmitted by the electronic device has been completed. In the case of the third situation 1030, the electronic device may determine that there is no more additional data to be transmitted, based on the MD field, and also, may receive an ACK to determine that there is no data required to be retransmitted. Therefore, in this case, the electronic device may no longer allocate an additional subevent within the CHS event and may prevent unnecessary waste of time resources or overhead.

According to various embodiments of the disclosure, the above-described situations are only examples and the disclosure is not limited thereto, and depending on a feedback signal (e.g., ACK/NACK) or a value of an MD field included in a data format transmitted by the electronic device, subevents having various lengths may be allocated in various manners. In addition, although FIG. 10 illustrates that only a first subevent is allocated as a default value, this is also only an example, and in consideration of a packet having a large capacity, two or more subevents may have been allocated from the beginning to enable divisional transmission of the packet.

FIG. 11 illustrates an operation flow of an electronic device for transmitting and receiving, based on a CHS structure, a signal according to various embodiments of the present disclosure. More specifically, FIG. 11 illustrates a flow of operations for transmitting an HDT data packet by an electronic device based on a CHS structure according to various embodiments of the disclosure.

In operation 1110, the electronic device may transmit a data packet within a first subevent period. According to an embodiment, the electronic device may perform communication for BLE and identify a transmission scheme according to a CHS structure. The electronic device may identify a CHG event including a CHS event, and identify a subevent included in the CHS event. In this case, depending on a number of packets to be transmitted, the number of subevents identified by the electronic device may be two or more. In addition, each of one or more CHS events included in the CHG event may correspond to each period for the electronic device to transmit data to a different external electronic device. According to an embodiment, the electronic device may obtain synchronization delay information for each of the one or more CHS events included in the CHG event, and thus may perform synchronization of the one or more CHS events, based on the information.

According to an embodiment, the electronic device may transmit a data packet to an external electronic device within an identified subevent period. A PDU of the data packet transmitted by the electronic device may include information on at least one of an MD field indicating whether additional transmission is required, an RI field for adjusting a transmission rate of a packet, or an FT value for the maximum number of CHS events in which each PDU may be transmitted. According to an embodiment, various fields or information included in the PDU of the data packet are specifically described in FIGS. 7A to 10.

In operation 1120, the electronic device may receive a feedback signal within the first subevent period. According to an embodiment, the electronic device may receive a feedback signal from the external electronic device within the identified subevent period. The feedback signal may include a selective ACK or NACK, and the specific content thereof is specifically described in FIGS. 8 to 10.

In operation 1130, the electronic device may determine a second subevent according to the feedback signal. According to an embodiment, when additional transmission is required according to an MD field value or when a NACK is received within the first subevent period, the electronic device may allocate another subevent for additional transmission. In this case, the length of an additionally allocated subevent may vary depending on a value of an RI field included in an HDT packet or the NACK of the feedback signal. According to an embodiment, the first subevent and the second subevent identified by the electronic device may be periods for transmitting a signal on the same frequency channel.

According to various embodiments of the disclosure, the above-described operations are only examples and the disclosure should not be limited thereto, and it is obvious that the electronic device may allocate more additional subevents according to a feedback signal. In addition, the above-mentioned names such as CHG or CHS are only examples, and may be referred to by various names as long as they include the same or similar structure. According to various embodiments of the disclosure, each of the configurations or operations of FIGS. 9 to 11 is not an essential component, and it is obvious that at least one of all, some, or a combination of some of the configurations or operations may be omitted, modified, or combined as necessary to achieve the same purpose and effect.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. For example, a part or all of an embodiment may be combined with a part or all of one or more other embodiments, and it is natural that an implementation of such combination also corresponds to an embodiment provided by the disclosure. Therefore, the scope of the disclosure should not be defined as being limited to the embodiments set forth herein, but should be defined by the appended claims and equivalents thereof.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a communication circuit for Bluetooth low energy (BLE); and
at least one processor coupled with the communication circuit, the at least one processor configured to:
identify a connected hybrid stream (CHS) group (CHG) event comprising a CHS event,
identify at least one subevent included in the CHS event,
transmit a data packet within a period of a first subevent among the at least one subevent, and
receive a feedback signal corresponding to the data packet within the period of the first subevent.

2. The electronic device of claim 1, wherein the feedback signal comprises at least one acknowledgement (ACK) or at least one negative ACK (NACK) corresponding to each payload included in the data packet.

3. The electronic device of claim 2, wherein the at least one processor is further configured to transmit a payload corresponding to the at least one NACK within a period of a second subevent among the at least one subevent in case that the feedback signal comprises the at least one NACK.

4. The electronic device of claim 3, wherein the first subevent and the second subevent are included in a channel over a same frequency band.

5. The electronic device of claim 1, wherein a protocol data unit (PDU) of the data packet comprises information on at least one of a more data (MD) indicator, a rate indicator (RI) field, or a flush timeout (FT) value.

6. The electronic device of claim 5, wherein a length of a payload of the data packet is determined based on the RI field.

7. The electronic device of claim 5, wherein a number of the at least one subevent included in the CHS event is determined based on the MD indicator.

8. The electronic device of claim 5, wherein the FT value comprises a value of a maximum number of the at least one subevent included in the CHS event.

9. The electronic device of claim 1, wherein the CHG event comprises one or more CHS events, and
wherein, among the one or more CHS events, a period of a first CHS event corresponds to a first external device and a period of a second CHS event corresponds to a second external device.

10. The electronic device of claim 9, wherein the at least one processor is further configured to receive first synchronization delay information corresponding to the first CHS event and second synchronization delay information corresponding to the second CHS event.

11. A method performed by an electronic device, the method comprising:
identifying a connected hybrid stream (CHS) group (CHG) event comprising a CHS event;
identifying at least one subevent included in the CHS event;
transmitting a data packet within a period of a first subevent among the at least one subevent; and
receiving a feedback signal corresponding to the data packet within the period of the first subevent.

12. The method of claim 11, wherein the feedback signal comprises at least one acknowledgement (ACK) or at least one negative ACK (NACK) corresponding to each payload included in the data packet.

13. The method of claim 12, further comprising transmitting a payload corresponding to the at least one NACK within a period of a second subevent among the at least one subevent in case that the feedback signal comprises the at least one NACK.

14. The method of claim 13, wherein the first subevent and the second subevent are included in a channel over a same frequency band.

15. The method of claim 11, wherein a protocol data unit (PDU) of the data packet comprises information on at least one of a more data (MD) indicator, a rate indicator (RI) field, or a flush timeout (FT) value.

16. The method of claim 15, wherein a length of a payload of the data packet is determined based on the RI field.

17. The method of claim 15, wherein a number of the at least one subevent included in the CHS event is determined based on the MD indicator.

18. The method of claim 15, wherein the FT value comprises a value of a maximum number of the at least one subevent included in the CHS event.

19. The method of claim 11, wherein the CHG event comprises one or more CHS events, and
wherein, among the one or more CHS events, a period of a first CHS event corresponds to a first external device and a period of a second CHS event corresponds to a second external device.

20. The method of claim 19, further comprising receiving first synchronization delay information corresponding to the first CHS event and second synchronization delay information corresponding to the second CHS event.
